(19) United States
(12) Patent Application Publication
(10) Pub. No.: US 2013/0275581 A1
(43) Pub. Date: Oct. 17, 2013

(54) Method for Monitoring Running Information of Applications and Related Apparatus

(71) Applicant: HTC CORPORATION, Taoyuan County (TW)

(72) Inventors: Chun-Ta Yu, Taoyuan County (TW); Yin-Yeh Tseng, Taoyuan County (TW)

(73) Assignee: HTC Corporation, Taoyuan County (TW)

(21) Appl. No.: 13/861,399

(22) Filed: Apr. 12, 2013

Related U.S. Application Data
(60) Provisional application No. 61/623,347, filed on Apr. 12, 2012.

(51) Int. Cl. H04L 29/08

(52) U.S. Cl. CPC H04L 67/22
USPC 709/224

(57) ABSTRACT

A method, used in an electronic device supporting a diagnostics and monitoring (DiagMon) management interface having a management object with a plurality of nodes, for monitoring running information of an application is disclosed. The method comprises identifying the application on a first node of the plurality of nodes; recording a total running time of the application on a second node of the plurality of nodes; recording a total user interactive time of the application on a third node of the plurality of nodes; recording a maximum memory usage which the application has used on a fourth node of the plurality of nodes; and recording a number of times which the application is activated by a user on a fifth node of the plurality of nodes.

### CROSS REFERENCE TO RELATED APPLICATIONS

This application claims the benefit of U.S. Provisional Application No. 61/623,347, filed on Apr. 12, 2012, entitled “Method to monitor running information of an application in DiagMon”, the contents of which are incorporated herein in their entirety.

### BACKGROUND OF THE INVENTION

1. Field of the Invention

The present invention relates to a method and apparatus utilized in an electronic device, and more particularly, to a method and apparatus of monitoring running information of applications in an electronic device.

2. Description of the Prior Art

More and more applications are installed in electronic devices, such as mobile phones, laptops, tablet computers, electronic books, and portable computer systems. The application execution information becomes valuable for developers of the applications or operators of networks, such as execution time, open counts, maximum memory usage and so on. For example, the installation times of an application can be regarded as the popularity of the application.

A generic management interface is used for diagnostics and monitoring (DiagMon) functions and broadly divided into two parts including DiagMon management objects (MO) and alert message. A server supporting the generic management interface can configure or invoke DiagMon functions via the generic management interface and further retrieve corresponding information. The interface framework does not present any specific function. Instead, it is intended to be used widely to present any DiagMon function. For this purpose, each DiagMon function has a specific management object identifier for identifying the DiagMon function represented by the framework. With the management object identifier, the DiagMon server is able to get further information of the DiagMon function.

In addition, the generic management interface is designed to support different processing types of various functions, such as synchronous, asynchronous or always running functions, and also to allow multiple instances corresponding to a certain function. In case of multiple instances, separate management objects are created for the multiple instances. The multiple instances can be distinguished by uniform resource identifiers (URI) of the management objects. In other words, the generic management interface provides a common template to allow flexible extensions or customization for different functions.

Therefore, it is worth to provide a function, which is represented by a specific framework such as a framework for DiagMon functions, to monitor valuable application execution information.

### SUMMARY OF THE INVENTION

The present invention therefore provides a method and apparatus for monitoring running information of applications in an electronic device, to provide the running information for further uses.

A method, used in an electronic device supporting a diagnostics and monitoring (DiagMon) management interface having a management object with a plurality of nodes, for monitoring running information of an application is disclosed. The method comprises identifying the application on a first node of the plurality of nodes; recording a total running time of the application on a second node of the plurality of nodes; recording a total user interactive time of the application on a third node of the plurality of nodes; recording a maximum memory usage which the application has used on a fourth node of the plurality of nodes; and recording a number of times which the application is activated by a user on a fifth node of the plurality of nodes.

An electronic device supporting a diagnostics and monitoring (DiagMon) management interface is disclosed. The electronic device comprises a processing means; a storage unit; and a program code, stored in the storage unit, wherein the program code instructs the processing means to execute a DiagMon function implemented by a management object (MO) with a plurality of nodes; wherein the DiagMon function comprises identifying an application on a first node of the plurality of nodes; recording a total running time of the application on a second node of the plurality of nodes; recording a total user interactive time of the application on a third node of the plurality of nodes; recording a maximum memory usage which the application has used on a fourth node of the plurality of nodes; and recording a number of times which the application is activated by a user on a fifth node of the plurality of nodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a network system according to an example of the present invention.

FIG. 2 is a schematic diagram of an electronic apparatus according to an example of the present invention.

FIG. 3 is a flowchart of a process according to an example of the present invention.

### DETAILED DESCRIPTION

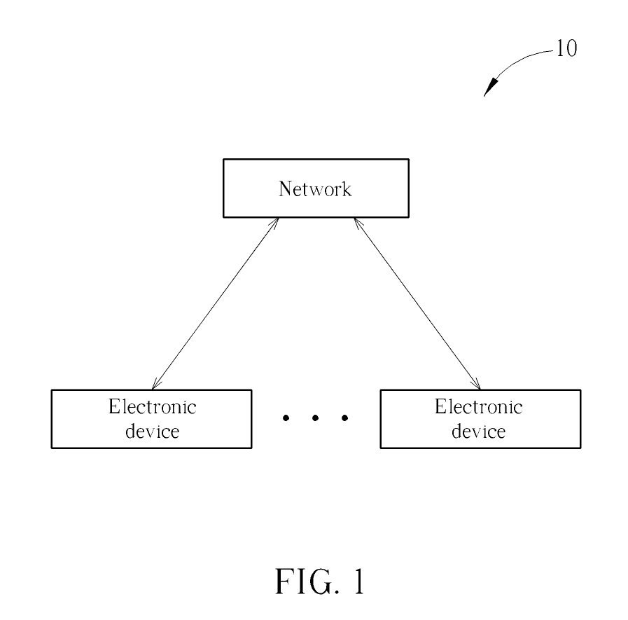

Please refer to FIG. 1, which is a schematic diagram of a network system 10 according to an example of the present invention. The network system 10 is briefly composed of a network and a plurality of electronic devices. In FIG. 1, the network and the electronic devices are simply utilized for illustrating the structure of the network system 10. Practically, the network can be a local area network system or a wireless communication system, such as a universal terrestrial radio access network (UTRAN) comprising a plurality of Node-Bs (NBs) in a universal mobile telecommunications system (UMTS) or an evolved UTRAN (E-UTRAN) comprising a plurality of evolved NBs (eNBs) and/or relays in a long term evolution (LTE) system or a LTE-Advanced (LTE-A) system. The network can also be a server. Moreover, the electronic devices can be mobile phones, laptops, tablet computers, electronic books, and portable computer systems.

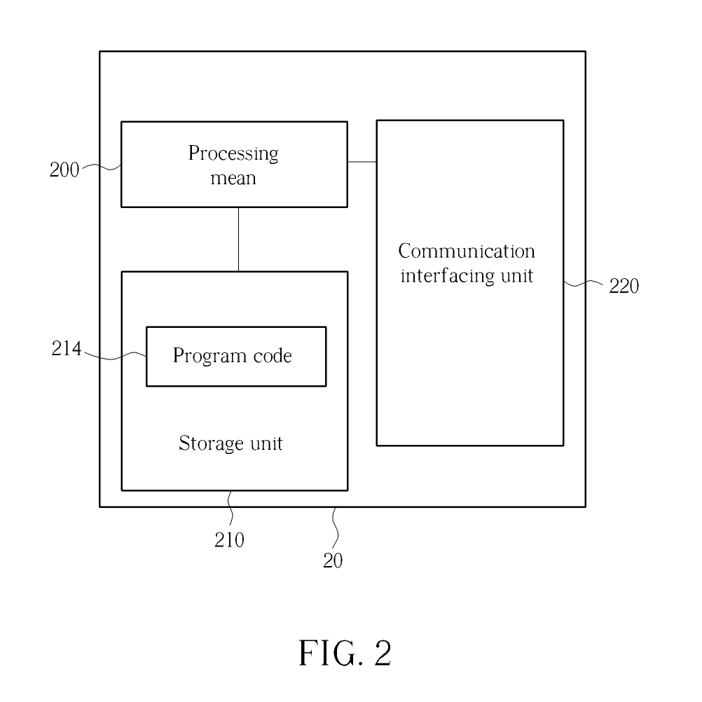

Please refer to FIG. 2, which is a schematic diagram of an electronic device 20 according to an example of the present invention. The electronic device 20 can be one of the electronic devices or the network shown in FIG. 1, but is not limited herein. The electronic device 20 may include a processing means 200 such as a microprocessor or Application Specific Integrated Circuit (ASIC), a storage unit 210 and a communication interfacing unit 220. The storage unit 210 may be any data storage device that can store a program code 214, accessed and executed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk and optical data storage device. The communication interfacing unit 220 is preferably a transceiver and is used to transmit and receive signals (e.g., messages or packets) according to processing results of the processing means 200.

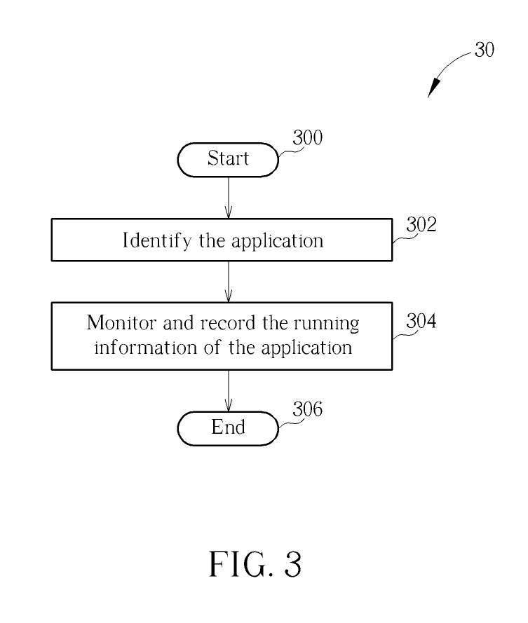

Please refer to FIG. 3, which is a flowchart of a process 30 according to an example of the present invention. The process 30 is utilized in the electronic device of the network system 10 shown in FIG. 1, for monitoring running information of an application. The process 30 may be compiled into the program code 214. The process 30 includes the following steps:

Step 300: Start.

Step 302: Identify the application.

Step 304: Monitor and record the running information of the application.

Step 306: End.

According to the process 30, the electronic device monitors and records the running information of the application, so that the running information may be provided to a corresponding person, such as a developer of the application, an operator of the network or a business man, for further uses.

In detail, in Step 304, the running information includes a total user interactive time of the application, a maximum memory usage which the application has ever used and a number of times which the application is activated by a user. In addition, when several applications are executed at the same time, the electronic device respectively records the running information of all applications and may further record an accumulation of the total running time of all applications, an accumulation of the total user interactive time of all applications or an accumulation of the maximum memory usage which all applications have ever used. Notably, the running time of the application is not added to the total user interactive time of the application when the application is executed in the background.

Note that, the process 30 is an example of the present invention. Those skilled in the art should readily make combinations, modifications and/or alterations on the abovementioned description and examples. For example, the running information may be used by the developer of the application to improve the application or the network operator to control and manage the network resources. The running information may also be used by an advertiser as a criterion to select a popular application to publish advertisements and further enhance commercial benefits.

The process 30 may be performed by various function frameworks. For example, the process 30 may be performed as a diagnostics and monitoring (DiagMon) function which is implemented by a management object (MO) with a plurality of nodes, when the electronic device supports a DiagMon management interface. Therefore, the network may retrieve the running information from the electronic device, when the network also supports the DiagMon management interface. In other words, the network supporting the DiagMon management interface may remotely control the electronic device to execute the DiagMon function to record the running information of the application on the plurality of nodes and further retrieve the running information from the electronic device, so that the running information may be provided to the network or even forwarded to someone such as the developer of the application or the business man for further uses. Notably, the DiagMon function is continuously available in the electronic device after invoked.

In the case of the MO implementing the DiagMon function, at least five nodes are configured. In detail, a first node is used for identifying the application; a second node is used for recording the total running time of the application; a third node is used for recording the total user interactive time of the application; a fourth node is used for recording the maximum memory usage which the application has ever used; and a fifth node is used for recording the number of times which the application is activated by the user. Therefore, the DiagMon function sets the values on the five nodes to be zero and follows to start to record the running information on the five nodes. Notably, the DiagMon function is invoked by receiving an execution command on a start node of the MO.

In addition, when several applications are executed at the same time, a sixth node, a seventh node and an eighth node may also be used respectively for recording an accumulation of the total running time of all applications, an accumulation of the total user interactive time of all applications, and an accumulation of the maximum memory usage which all applications have ever used.

In the present invention, the electronic device monitors and records the running information of the applications. Therefore, the running information can be provided to improve the application, to control the resources for the application, or to enhance the commercial value of the application.

To sum up, the present invention provides a function or an electronic device to monitor running information of applications so that the running information can be recorded and provided for further uses.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for monitoring running information of an application, used in an electronic device supporting a diagnostics and monitoring (DiagMon) management interface having a management object with a plurality of nodes, the method comprising:
identifying the application on a first node of the plurality of nodes;
recording a total running time of the application on a second node of the plurality of nodes;
recording a total user interactive time of the application on a third node of the plurality of nodes;
recording a maximum memory usage which the application has used on a fourth node of the plurality of nodes; and
recording a number of times which the application is activated by a user on a fifth node of the plurality of nodes.

2. The method of claim 1, further comprising recording an accumulation of the total running time of the application and other applications on a sixth node of the plurality of nodes.

3. The method of claim 1, further comprising recording an accumulation of the total user interactive time of the application and other applications on a seventh node of the plurality of nodes.

4. The method of claim 1, further comprising recording an accumulation of the maximum memory usage which the application and other applications have used on an eighth node of the plurality of nodes.

5. An electronic device, supporting a diagnostics and monitoring (DiagMon) management interface, comprising:
a processing means;
a storage unit; and
a program code, stored in the storage unit, wherein the program code instructs the processing means to execute a DiagMon function implemented by a management object (MO) with a plurality of nodes;
wherein the DiagMon function comprises:
identifying an application on a first node of the plurality of nodes;
recording a total running time of the application on a second node of the plurality of nodes;
recording a total user interactive time of the application on a third node of the plurality of nodes;
recording a maximum memory usage which the application has used on a fourth node of the plurality of nodes; and
recording a number of times which the application is activated by a user on a fifth node of the plurality of nodes.

6. The electronic device of claim 5, wherein the DiagMon function further comprises recording an accumulation of the total running time of the application and other applications on a sixth node of the plurality of nodes.

7. The electronic device of claim 5, wherein the DiagMon function further comprises recording an accumulation of the total user interactive time of the application and other applications on a seventh node of the plurality of nodes.

8. The electronic device of claim 5, wherein the DiagMon function further comprises recording an accumulation of the maximum memory usage which the application and other applications have used on an eighth node of the plurality of nodes.

9. The electronic device of claim 5, wherein the DiagMon function is invoked by receiving an execution command on a start node of the plurality of nodes.

10. The electronic device of claim 5, wherein the DiagMon function is continuously available.
